(19) United States
(12) Patent Application Publication
(10) Pub. No.: US 2008/0202313 A1
(43) Pub. Date: Aug. 28, 2008

(54) Chain link strap for a musical instrument and associated method

(76) Inventor: Steven C. Ruel, Fontana, CA (US)

Correspondence Address: ASHKAN NAJAFI, P.A., 6817 SOUTHPOINT PARKWAY, SUITE 2301, JACKSONVILLE, FL, 32216, US

(21) Appl. No.: 12/070,847

(22) Filed: Feb. 21, 2008

Related U.S. Application Data
(60) Provisional application No. 60/902,905, filed on Feb. 23, 2007.

(51) Int. Cl. G10D 3/00

(52) U.S. Cl. 84/327

(57) ABSTRACT

A combined guitar and chain link strap includes a guitar, a stainless steel chain formed from an array of rigid rings interlinked along an end-to-end pattern, and a mechanism for adjustably conjoining opposed ends of the chain to corresponding opposed ends of the guitar such that the chain freely oscillates and travels along varying paths while remaining spaced from the guitar and thereby permitting a user to twist and turn in sync with the chain while the guitar remains stationary. Such an adjustably conjoining mechanism includes first and second hoops directly and dynamically anchored to the opposed ends of the guitar so that the hoops freely pivot in alternate directions.

### CROSS REFERENCE TO RELATED APPLICATIONS

This application claims the benefit of U.S. Provisional Application No. 60/902,905, filed Feb. 23, 2008, the entire disclosures of which are incorporated herein by reference.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Technical Field

This invention relates to musical instruments and, more particularly, to a chain link strap for a musical instrument for providing a customized musical instrument.

2. Prior Art

Stringed instruments such as banjos, ukuleles, mandolins, guitars and the like are often played while the performer is standing and holding the instrument in front of their body. For most of these instruments, just positioning and holding the instrument in front of the body during performance is sufficient throughout the entire performance. Guitars, however, are somewhat singular in that the performer, during performance, often wishes to maneuver the instrument into positions other than the conventional front-of-the-body position. Particularly in the field of rock music guitar players, it is quite common for guitarists to swing the guitar wildly about themselves, above their heads, and down near the floor or other supporting surface during the performance.

With performances lasting up to several hours, holding the guitar in a playable position is extremely tiring and can cause sufficient fatigue in the performers' arms and hands as to reduce the performers' artistic abilities and speed. With no support for the guitar following these wild maneuvers, it becomes even more of a strain on the performer. Such strain is alleviated through the use of guitar straps. Such straps attach to the guitar in such a way that some of the weight of the guitar is supported by the user body thus reducing strain on the user arms. Most guitar straps are decorative and personalized, but are also available only as canvas or cloth designs. Based on the above mentioned needs, it would be advantageous to provide a guitar strap manufactured of chain link metal for presenting a striking alternative to traditional leather or canvas guitar straps.

U.S. Pat. No. 7,169,992 to Kennon discloses a guitar strap, for supporting a guitar, having a guitar body, and a pair of attachment knobs affixed to the guitar body. The attachment knobs have a neck and a flange, the flange larger in diameter than the neck. The guitar strap has a belt having a first and second end, and a pair of connecting pads, each connecting pad located at one of the first and second ends of the belt. The connecting pads each have a securing hole having a securing hole circumference, which has a relaxed, smaller size, but when pressed down upon one of the attachment knobs enlarges and allows the flange to pass therethrough, and then relaxes and retracts to extend snugly around the neck once the connecting pad has been moved below the flange. Unfortunately, this prior art example does not provide a dazzling way in which to enhance the appearance of various musical instruments.

U.S. Pat. No. 6,791,018 to Bazata discloses a guitar sling that allows the musician to move and hold the guitar in any desirable instrument position with respect to the musician's body and that will “self-balance” the guitar in any position or orientation while the guitar is played. The sling consists of four basic components: a guitar strap, a length of cord, cord locks, a fixed strap coupler and a traveling strap coupler. The length of cord is connected between the strap buttons of the guitar and drawn taut across the back of the guitar body by the cord locks. The fixed strap coupler is connected to the strap button at the base of the guitar neck. The traveling strap coupler is mounted to the cord to freely slide along the length of the cord. One end of the guitar strap is connected to the fixed strap coupler while the other end is connected to the traveling strap coupler. Unfortunately, this prior art example does not provide a dazzling way in which to enhance the appearance of various musical instruments.

U.S. Pat. No. 6,590,145 to Doiron discloses a locking guitar strap which can be securely attached to the button of a guitar or other stringed instrument by means of a locking mechanism mounted internally into the end tab of the guitar strap, thus preventing damage to the instrument by accidental disengagement of the strap from the instrument. Unfortunately, this prior art example does not provide a dazzling way in which to enhance the appearance of various musical instruments.

Accordingly, the present invention is disclosed in order to overcome the above noted shortcomings. The combined guitar and chain link strap is convenient and easy to use, durable in design, and designed for providing a customized musical instrument. The assembly is simple to use, affordable, and designed for many years of repeated use.

### BRIEF SUMMARY OF THE INVENTION

In view of the foregoing background, it is therefore an object of the present invention to provide an assembly for providing a customized musical instrument. These and other objects, features, and advantages of the invention are provided by a combined guitar and chain link strap.

A combined guitar and chain link strap includes a guitar, a stainless steel chain effectively formed from an array of rigid rings interlinked along an end-to-end pattern, and a mechanism for adjustably conjoining opposed ends of the chain to corresponding opposed ends of the guitar such that the chain freely oscillates and travels along varying paths while remaining spaced from the guitar and thereby permitting a user to twist and turn in sync with the chain while the guitar remains stationary.

Such an adjustably conjoining mechanism includes first and second hoops directly and dynamically anchored to the opposed ends of the guitar so that the hoops conveniently freely pivot in alternate directions. The mechanism further includes first and second slotted fastening members removably engaged directly with the first and second hoops respectively. Each of the first and second fastening members has a curvilinear hook formed at one end thereof and further has a neck provided with an eyelet formed at an opposite end thereof. First and second triggers are pivotally coupled directly to the fastening members and are rotatable along clockwise and counter clockwise directions respectively. Each of such first and second triggers includes first and second monolithically formed rectilinear fingers protruding outwardly along first and second mutually exclusive paths respectively. Such a first finger is directly abutted against a first end of the hook while such a second finger is directly aligned and engaged with a second end of the hook such that the first and second hoops are prevented from disengaging the first and second fastening members. The first and second fingers are simultaneously disengaged from the first and second ends of the hook while remaining registered orthogonal to each other.

The adjustably conjoining mechanism further includes first and second auxiliary links directly attached to the first and second eyelets, and first and second stabilizing plates directly mated with the first and second auxiliary links respectively. Distal and proximal ones of the rings are statically attached directly to the first and second stabilizing plates for advantageously maintaining the chain spaced from the first and second fastening members and thereby ensuring that the first and second triggers remain disposed at closed positions during the twisting and turning movements.

The adjustably conjoining mechanism includes a first coupling directly mated to one of the guitar ends, a first rectilinear anchor rod with axially opposed proximal and distal ends statically anchored to the coupling and extending away from the one guitar end respectively, and a chamfered bracket rotatably engaged directly with the distal end of the anchor rod such that the chamfered bracket is effectively rotated along a first arcuate path. Such a chamfered bracket has a linear slot formed along a major longitudinal length thereof. The mechanism further includes a second rectilinear rod slidably positioned through the slot and provided with a second coupling attached to a proximal end thereof so that the second rod is prevented from being released from the slot. A tongue is rotatably conjoined directly to a distal end of the second rod and is freely articulated along a second arcuate path. The first and second arcuate paths are mutually exclusive, and the tongue simultaneously rotates about the second rod while the chamfered bracket rotates about the first rod.

The first and second rods are registered parallel to each other and remain offset such that rotation of the chamfered bracket about the first rod conveniently communicates a linear motion to the second rod along a longitudinal length of the chamfered bracket with a varying velocity and thereby continuously changes a spatial distance between the first and second rods.

A method for providing a customized musical instrument includes the steps of: providing a guitar; providing a stainless steel chain formed from an array of rigid rings interlinked along an end-to-end pattern; adjustably conjoining opposed ends of the chain to corresponding opposed ends of the guitar; and the chain freely oscillating and traveling along varying paths while remaining spaced from the guitar and thereby permitting a user to twist and turn in sync with the chain while the guitar remains stationary.

The method further includes the steps of: providing and directly and dynamically anchoring first and second hoops to the opposed ends of the guitar so that the hoops freely pivot in alternate directions; providing and removably engaging first and second slotted fastening members directly with the first and second hoops respectively, each of the first and second fastening members having a curvilinear hook formed at one end thereof and further having a neck provided with an eyelet formed at an opposite end thereof; providing and pivotally coupling first and second triggers directly to the fastening members; and the first and second triggers rotating along clockwise and counter clockwise directions respectively.

The method further includes the steps of: providing first and second orthogonally disposed fingers; and simultaneously disengaging the first and second fingers from the first and second ends of the hook while remaining registered orthogonal to each other.

The method further includes the steps of: providing and directly attaching first and second auxiliary links to the first and second eyelets; providing and directly mating first and second stabilizing plates with the first and second auxiliary links respectively; and maintaining the chain spaced from the first and second fastening members and thereby ensuring that the first and second triggers remain disposed at closed positions during the twisting and turning movements by statically attaching distal and proximal ones of the rings directly to the first and second stabilizing plates.

The method further includes the steps of: providing and directly mating a first coupling to one of the guitar ends; providing and statically anchoring a proximal end of a first rectilinear anchor rod to the coupling while a distal end of the anchor rod extends away from the one guitar end respectively; providing and rotatably engaging a chamfered bracket directly with the distal end of the anchor rod; the chamfered bracket rotating along a first arcuate path, the chamfered bracket having a linear slot formed along a major longitudinal length thereof; providing and slidably positioning a second rectilinear rod through the slot; providing and attaching a second coupling to a proximal end of the second rod so that the second rod is prevented from being released from the slot; providing and rotatably conjoining a tongue directly to a distal end of the second rod; and freely articulating the tongue along a second arcuate path wherein the first and second arcuate paths are mutually exclusive.

The method further includes the steps of: simultaneously rotating the tongue about the second rod while the chamfered bracket rotates about the first rod; communicating a linear motion to the second rod along a longitudinal length of the chamfered bracket with a varying velocity; and continuously changing a spatial distance between the first and second rods.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

It is noted the purpose of the foregoing abstract is to enable the U.S. Patent and Trademark Office and the public generally, especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE SEVERAL VIEWS OF THE DRAWING

The novel features believed to be characteristic of this invention are set forth with particularity in the appended claims. The invention itself, however, both as to its organization and method of operation, together with further objects and advantages thereof, may best be understood by reference to the following description taken in connection with the accompanying drawings in which:

FIG. 1 is a front elevational view of a combined guitar and chain link strap, with enlarged views of the adjustably conjoining mechanism, in accordance with the present invention;

FIG. 2 is an enlarged view of a slotted fastening mechanism as seen in FIG. 1;

FIG. 3 is an enlarged view of the slotted fastening mechanism as seen in FIG. 1, showing the movement of the trigger, in accordance with the present invention;

FIG. 4 is a front elevational view of an alternate embodiment of the combined guitar and chain link strap, with enlarged views of the adjustably conjoining mechanism, in accordance with the present invention;

FIG. 5 is an enlarged perspective view of the adjustably conjoining mechanism, in accordance with the present invention; and

FIG. 6 is another enlarged perspective view of the adjustably conjoining mechanism, in accordance with the present invention.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this application will be thorough and complete, and will fully convey the true scope of the invention to those skilled in the art. Like numbers refer to like elements throughout the figures.

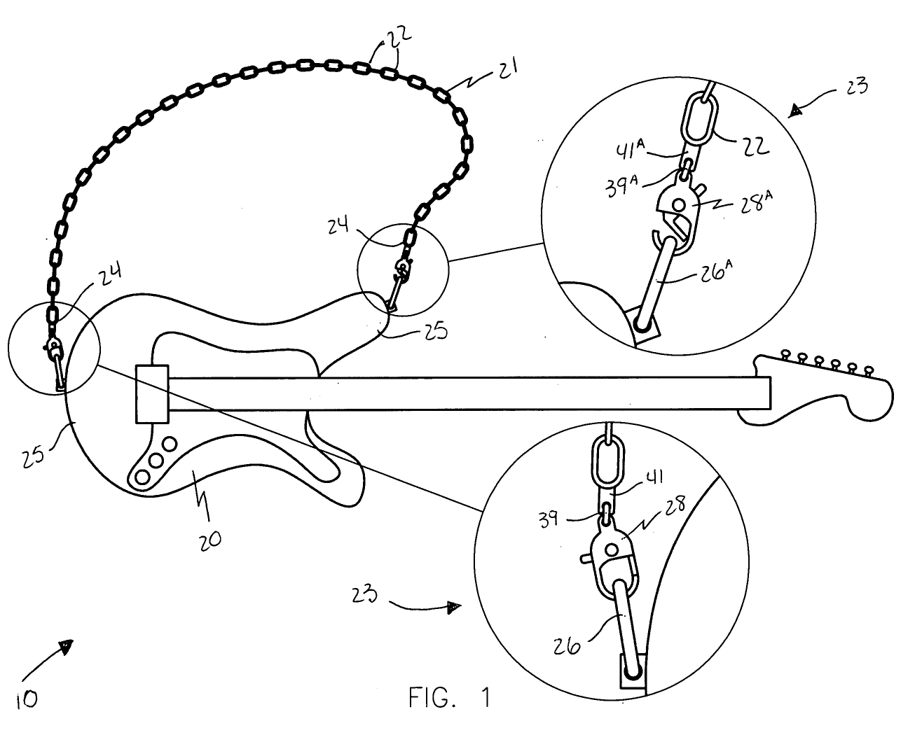

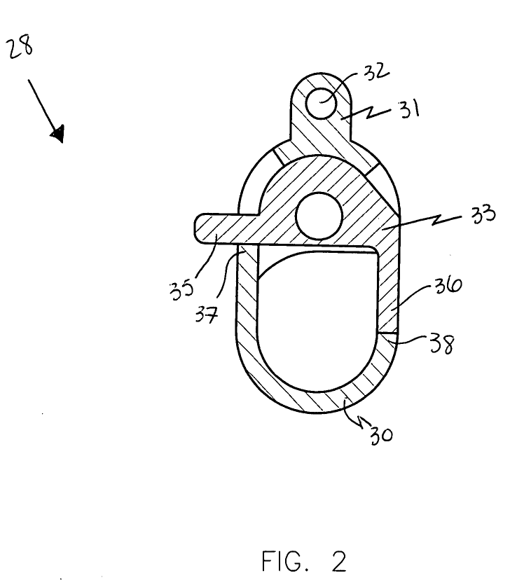

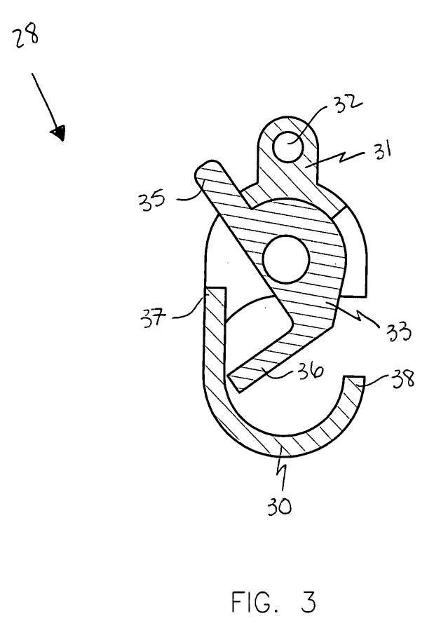

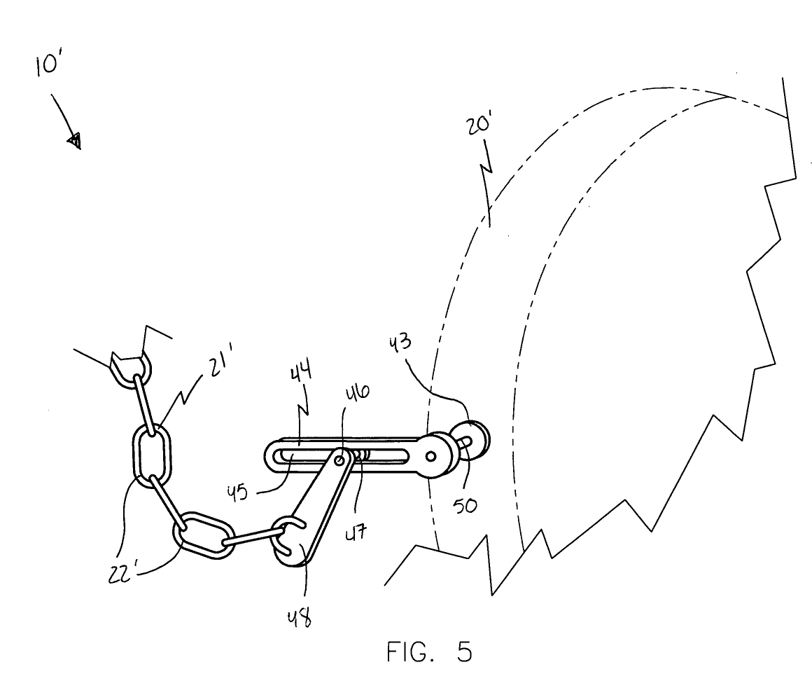

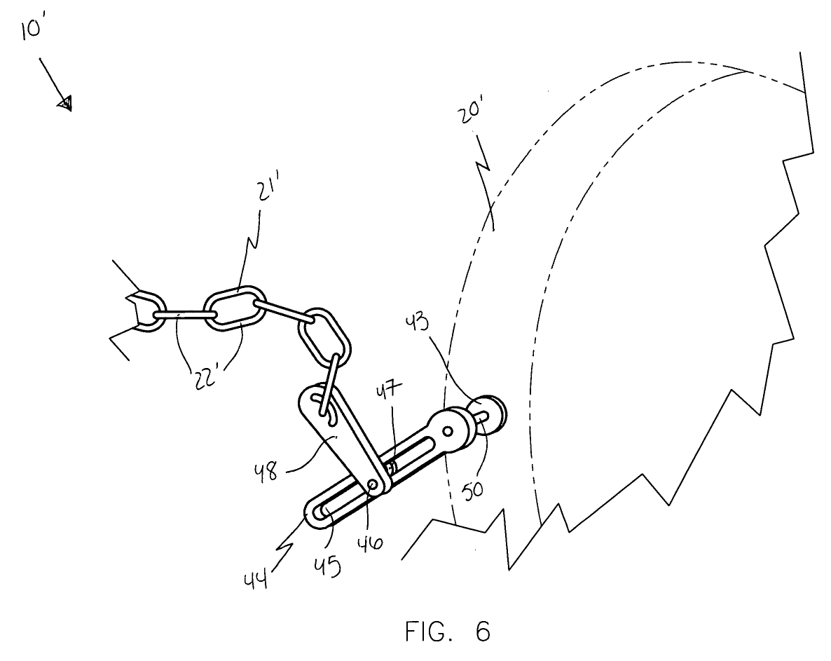

The apparatus of this invention is referred to generally in FIGS. 1-6 by the reference numeral 10 and is intended to protect a combined guitar and chain link strap. It should be understood that the apparatus 10 may be used to protect many different types of musical instruments and should not be limited to use with only those types of musical instruments mentioned herein.

Referring initially to FIGS. 1, 2 and 3, a combined guitar and chain link strap 10 includes a guitar 20, a stainless steel chain 21 formed from an array of rigid rings 22 interlinked along an end-to-end pattern, and a mechanism 23 for adjustably conjoining opposed ends 24 of the chain 21 to corresponding opposed ends 25 of the guitar 20 which is essential such that the chain 21 freely oscillates and travels along varying paths while remaining spaced from the guitar 20 and thereby permitting a user to twist and turn in sync with the chain 21 while the guitar 20 remains stationary. The chain link design provides a functional yet attractive design.

Such an adjustably conjoining mechanism 23 includes first and second hoops 26, 26 directly and dynamically anchored, without the use of intervening elements, to the opposed ends 25 of the guitar 20 so that the hoops 26, 26^{A} freely pivot in alternate directions. The mechanism 23 further includes first and second slotted fastening members 28, 28^{A} removably engaged directly, without the use of intervening elements, with the first and second hoops 26, 26^{A} respectively. Each of the first and second fastening members 28, 28^{A} has a curvilinear hook 30 formed at one end thereof and further has a neck 31 provided with an eyelet 32 formed at an opposite end thereof. First and second triggers 33, 34 are pivotally coupled directly, without the use of intervening elements, to the fastening members 28, 28^{A} and are rotatable along clockwise and counter clockwise directions respectively. Each of such first and second triggers 33, 33^{A} includes first and second monolithically formed rectilinear fingers 35, 36 protruding outwardly along first and second mutually exclusive paths respectively. Such a first finger 35 is directly abutted, without the use of intervening elements, against a first end of the hook 30 while such a second finger 36 is directly aligned and engaged, without the use of intervening elements, with a second end of the hook 30 which is crucial such that the first and second hoops 26, 26^{A} are prevented from disengaging the first and second fastening members 28, 28^{A}. The first and second fingers 35, 36 are simultaneously disengaged from the first and second ends 37, 38 of the hook 30 while remaining registered orthogonal to each other. The adjustably conjoining mechanism 23 enables a user to remove the strap from the guitar as needed.

Referring again to FIGS. 1, 2 and 3, the adjustably conjoining mechanism 23 further includes first and second auxiliary links 39, 39^{A} directly attached, without the use of intervening elements, to the first and second eyelets 32, and first and second stabilizing plates 41, 41^{A} directly mated, without the use of intervening elements, with the first and second auxiliary links 39, 39^{A} respectively. Distal and proximal ones of the rings 22 are statically attached directly, without the use of intervening elements, to the first and second stabilizing plates 41, 41^{A} for maintaining the chain 21 spaced from the first and second fastening members 28, 28^{A} and thereby ensuring that the first and second triggers 33, 34 remain disposed at closed positions during the twisting and turning movements.

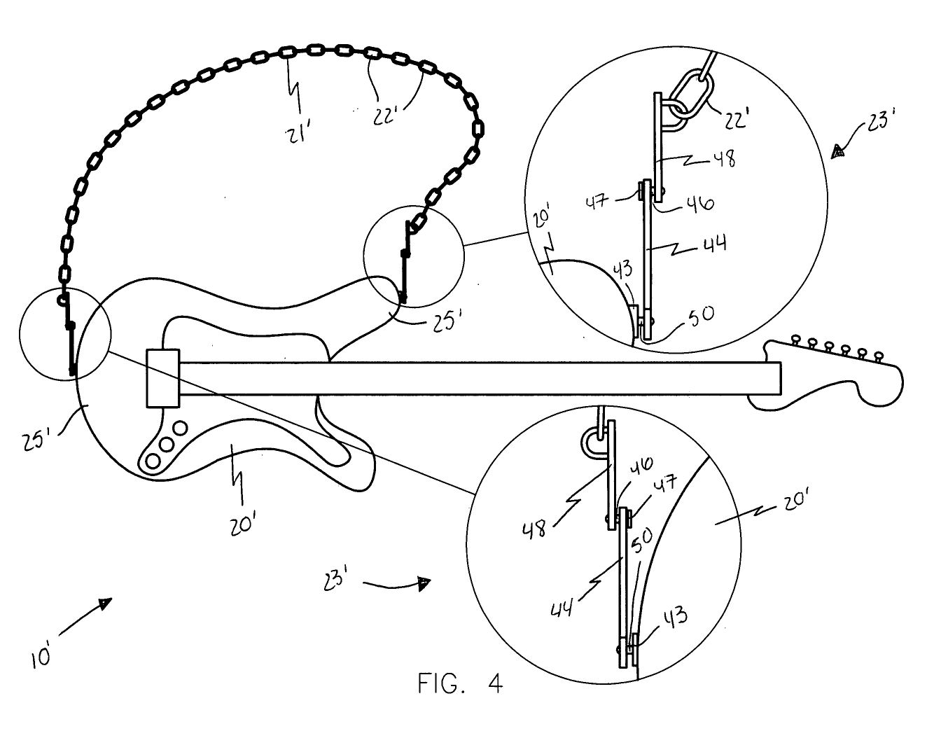

Referring to FIGS. 4, 5 and 6, the adjustably conjoining mechanism 23 includes a first coupling 43 directly mated, without the use of intervening elements, to one of the guitar ends, a first rectilinear anchor rod 50 with axially opposed proximal and distal ends statically anchored to the coupling 43 and extending away from the one guitar end respectively, and a chamfered bracket 44 rotatably engaged directly, without the use of intervening elements, with the distal end of the anchor rod 43 which is important such that the chamfered bracket 44 is rotated along a first arcuate path. Such a chamfered bracket 44 has a linear slot 45 formed along a major longitudinal length thereof. The mechanism 23 further includes a second rectilinear rod 46 slidably positioned through the slot 45 and provided with a second coupling 47 attached to a proximal end thereof so that the second rod 46 is prevented from being released from the slot 45. A tongue 48 is rotatably conjoined directly, without the use of intervening elements, to a distal end of the second rod 46 and is freely articulated along a second arcuate path. The first and second arcuate paths are mutually exclusive, and the tongue 48 simultaneously rotates about the second rod 46 while the chamfered bracket 44 rotates about the first rod 50.

The first and second rods 50, 46 are registered parallel to each other and remain offset which is crucial such that rotation of the chamfered bracket 44 about the first rod 50 communicates a linear motion to the second rod 46 along a longitudinal length of the chamfered bracket 44 with a varying velocity and thereby continuously changes a spatial distance between the first and second rods 50, 46.

The present invention includes a guitar strap constructed primarily of chain link metal material. Manufactured primarily of heavy duty stainless steel, aluminum, or similar metal material, the combined guitar and chain link guitar strap is produced in a variety of sizes ranging from ¼-½″ in width and 24″-54″ in length, as examples, thus accommodating various users, as well as the many sizes of acoustic, electric and bass guitars available on the market. Further, the guitar strap is adjustable, enabling the user to lengthen or shorten the strap in order to customize the assembly to accommodate the user proportions. Durable fasteners are positioned at either end of the strap for use in securing the apparatus to an existing instrument. These fasteners can be lined in felt or similar soft material, as examples, thus protecting the surface of the guitar. The strap can be produced in shiny silver and other metallic hues, as well as bright colors including pink, as examples.

The present invention, as claimed, provides the unexpected and unpredictable benefit of an assembly that is convenient and easy to use, is lightweight yet durable in design, and presents a striking alternative to traditional leather or canvas guitar straps. Such a guitar strap is an innovative design that provides guitar enthusiasts with a sturdy, reliable support for the instrument. An eye-catching alternative to traditional, flat leather, canvas or nylon straps, the guitar strap also provides a dazzling way in which to enhance the appearance of the guitar itself. Versatile in function, the guitar strap can be used in conjunction with virtually any acoustic, electric or bass guitar, as well as diverse instruments such as a banjo or mandolin. The present invention is inexpensive, simple to use, and designed for many years of repeated use.

In use, a method for providing a customized musical instrument includes the steps of: providing a guitar 20; providing a stainless steel chain 21 formed from an array of rigid rings 22 interlinked along an end-to-end pattern; adjustably conjoining opposed ends of the chain 21 to corresponding opposed ends 25 of the guitar 20; and the chain 21 freely oscillating and traveling along varying paths while remaining spaced from the guitar 20 and thereby permitting a user to twist and turn in sync with the chain 21 while the guitar 20 remains stationary.

In use, the method further includes the steps of: providing and directly and dynamically anchoring, without the use of intervening elements, first and second hoops 26, 26^{A} to the opposed ends 25 of the guitar 20 so that the hoops 26, 26^{A} freely pivot in alternate directions; providing and removably engaging first and second slotted fastening members 28, 28^{A} directly, without the use of intervening elements, with the first and second hoops 26, 26^{A} respectively, each of the first and second fastening members 28, 28^{A} having a curvilinear hook 30 formed at one end thereof and further having a neck 31 provided with an eyelet 32 formed at an opposite end thereof; providing and pivotally coupling first and second triggers 33, 34 directly, without the use of intervening elements, to the fastening members 28, 28^{A}; and the first and second triggers 33, 34 rotating along clockwise and counter clockwise directions respectively.

In use, the method further includes the steps of: providing first and second orthogonally disposed fingers 35, 36; and simultaneously disengaging the first and second fingers 35, 36 from the first and second ends 37, 38 of the hook 30 while remaining registered orthogonal to each other.

In use, the method further includes the steps of: providing and directly attaching first and second auxiliary links 39, 39^{A}, without the use of intervening elements, to the first and second eyelets 32; providing and directly, without the use of intervening elements, mating first and second stabilizing plates 41, 41^{A} with the first and second auxiliary links 39, 39^{A} respectively; and maintaining the chain 21 spaced from the first and second fastening members 28, 28^{A} and thereby ensuring that the first and second triggers 33, 34 remain disposed at closed positions during the twisting and turning movements by statically attaching distal and proximal ones of the rings 22 directly, without the use of intervening elements, to the first and second stabilizing plates 41, 41^{A}.

In use, the method further includes the steps of: providing and directly mating, without the use of intervening elements, a first coupling 43 to one of the guitar ends 25; providing and statically anchoring a proximal end of a first rectilinear anchor rod 50 to the coupling 43 while a distal end of the anchor rod 50 extends away from the one guitar end 25 respectively; providing and rotatably engaging a chamfered bracket 44 directly, without the use of intervening elements, with the distal end of the anchor rod 50; the chamfered bracket 44 rotating along a first arcuate path, the chamfered bracket 44 having a linear slot 45 formed along a major longitudinal length thereof; providing and slidably positioning a second rectilinear rod 46 through the slot 45; providing and attaching a second coupling 47 to a proximal end of the second rod 46 so that the second rod 46 is prevented from being released from the slot 45; providing and rotatably conjoining a tongue 48 directly, without the use of intervening elements, to a distal end of the second rod 46; and freely articulating the tongue 48 along a second arcuate path wherein the first and second arcuate paths are mutually exclusive.

In use, the method further includes the steps of: simultaneously rotating the tongue 48 about the second rod 46 while the chamfered bracket 44 rotates about the first rod 50; communicating a linear motion to the second rod 46 along a longitudinal length of the chamfered bracket 44 with a varying velocity; and continuously changing a spatial distance between the first and second rods 50, 46.

While the invention has been described with respect to a certain specific embodiment, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts of the present invention may include variations in size, materials, shape, form, function and manner of operation. The assembly and use of the present invention are deemed readily apparent and obvious to one skilled in the art.

What is claimed as new and what is desired to secure by Letters Patent of the United States is:

1. A combined guitar and chain link strap for providing a customized musical instrument, said combined guitar and chain link strap comprising:
a guitar;
a chain formed from an array of rigid rings interlinked along an end-to-end pattern; and
means for adjustably conjoining opposed ends of said chain to corresponding opposed ends of said guitar such that said chain freely oscillates and travels along varying paths and thereby permitting a user to twist and turn in sync with said chain while said guitar remains stationary.

2. The combined guitar and chain link strap of claim 1, wherein said adjustably conjoining means comprises:
first and second hoops directly and dynamically anchored to said opposed ends of said guitar so that said hoops freely pivot in alternate directions;
first and second slotted fastening members removably engaged directly with said first and second hoops respectively, each of said first and second fastening members having a curvilinear hook formed at one end thereof and further having a neck provided with an eyelet formed at an opposite end thereof; and
first and second triggers pivotally coupled directly to said fastening members and being rotatable along clockwise and counter clockwise directions respectively.

3. The combined guitar and chain link strap of claim 2, wherein each of said first and second triggers comprises:
first and second monolithically formed rectilinear fingers protruding outwardly along first and second mutually exclusive paths respectively, said first finger being directly abutted against a first end of said hook while said second finger is directly aligned and engaged with a second end of said hook such that said first and second hoops are prevented from disengaging said first and second fastening members;
wherein said first and second fingers are simultaneously disengaged from said first and second ends of said hook while remaining registered orthogonal to each other.

4. The combined guitar and chain link strap of claim 3, wherein said adjustably conjoining means further comprises:
first and second auxiliary links directly attached to said first and second eyelets; and
first and second stabilizing plates directly mated with said first and second auxiliary links respectively;
wherein distal and proximal ones of said rings are statically attached directly to said first and second stabilizing plates for maintaining said chain spaced from said first and second fastening members and thereby ensuring that said first and second triggers remain disposed at closed positions during the twisting and turning movements.

5. The combined guitar and chain link strap of claim 1, wherein said adjustably conjoining means comprises:
a first coupling directly mated to one of said guitar ends;
a first rectilinear anchor rod having axially opposed proximal and distal ends statically anchored to said coupling and extending away from said one guitar end respectively;
a chamfered bracket rotatably engaged directly with said distal end of said anchor rod such that said chamfered bracket is rotated along a first arcuate path, said chamfered bracket having a linear slot formed along a major longitudinal length thereof;
a second rectilinear rod slidably positioned through said slot and being provided with a second coupling attached to a proximal end thereof so that said second rod is prevented from being released from said slot; and
a tongue rotatably conjoined directly to a distal end of said second rod and being freely articulated along a second arcuate path;
wherein said first and second arcuate paths are mutually exclusive.

6. The combined guitar and chain link strap of claim 5, wherein said first and second rods are registered parallel to each other and remain offset such that rotation of said chamfered bracket about said first rod communicates a linear motion to said second rod along a longitudinal length of said chamfered bracket with a varying velocity and thereby continuously changes a spatial distance between said first and second rods.

7. The combined guitar and chain link strap of claim 5, wherein said tongue simultaneously rotates about said second rod while said chamfered bracket rotates about said first rod.

8. A combined guitar and chain link strap for providing a customized musical instrument, said combined guitar and chain link strap comprising:
a guitar;
a stainless steel chain formed from an array of rigid rings interlinked along an end-to-end pattern; and
means for adjustably conjoining opposed ends of said chain to corresponding opposed ends of said guitar such that said chain freely oscillates and travels along varying paths while remaining spaced from said guitar and thereby permitting a user to twist and turn in sync with said chain while said guitar remains stationary.

9. The combined guitar and chain link strap of claim 8, wherein said adjustably conjoining means comprises:
first and second hoops directly and dynamically anchored to said opposed ends of said guitar so that said hoops freely pivot in alternate directions;
first and second slotted fastening members removably engaged directly with said first and second hoops respectively, each of said first and second fastening members having a curvilinear hook formed at one end thereof and further having a neck provided with an eyelet formed at an opposite end thereof; and
first and second triggers pivotally coupled directly to said fastening members and being rotatable along clockwise and counter clockwise directions respectively.

10. The combined guitar and chain link strap of claim 9, wherein each of said first and second triggers comprises:
first and second monolithically formed rectilinear fingers protruding outwardly along first and second mutually exclusive paths respectively, said first finger being directly abutted against a first end of said hook while said second finger is directly aligned and engaged with a second end of said hook such that said first and second hoops are prevented from disengaging said first and second fastening members;
wherein said first and second fingers are simultaneously disengaged from said first and second ends of said hook while remaining registered orthogonal to each other.

11. The combined guitar and chain link strap of claim 10, wherein said adjustably conjoining means further comprises:
first and second auxiliary links directly attached to said first and second eyelets; and
first and second stabilizing plates directly mated with said first and second auxiliary links respectively;
wherein distal and proximal ones of said rings are statically attached directly to said first and second stabilizing plates for maintaining said chain spaced from said first and second fastening members and thereby ensuring that said first and second triggers remain disposed at closed positions during the twisting and turning movements.

12. The combined guitar and chain link strap of claim 8, wherein said adjustably conjoining means comprises:
a first coupling directly mated to one of said guitar ends;
a first rectilinear anchor rod having axially opposed proximal and distal ends statically anchored to said coupling and extending away from said one guitar end respectively;
a chamfered bracket rotatably engaged directly with said distal end of said anchor rod such that said chamfered bracket is rotated along a first arcuate path, said chamfered bracket having a linear slot formed along a major longitudinal length thereof;
a second rectilinear rod slidably positioned through said slot and being provided with a second coupling attached to a proximal end thereof so that said second rod is prevented from being released from said slot; and
a tongue rotatably conjoined directly to a distal end of said second rod and being freely articulated along a second arcuate path;
wherein said first and second arcuate paths are mutually exclusive.

13. The combined guitar and chain link strap of claim 12, wherein said first and second rods are registered parallel to each other and remain offset such that rotation of said chamfered bracket about said first rod communicates a linear motion to said second rod along a longitudinal length of said chamfered bracket with a varying velocity and thereby continuously changes a spatial distance between said first and second rods.

14. The combined guitar and chain link strap of claim 12, wherein said tongue simultaneously rotates about said second rod while said chamfered bracket rotates about said first rod.

15. A method for providing a customized musical instrument, said method comprising the steps of:
a. providing a guitar;
b. providing a stainless steel chain formed from an array of rigid rings interlinked along an end-to-end pattern;
c. adjustably conjoining opposed ends of said chain to corresponding opposed ends of said guitar; and
d. said chain freely oscillating and traveling along varying paths while remaining spaced from said guitar and thereby permitting a user to twist and turn in sync with said chain while said guitar remains stationary.

16. The method of claim 15, wherein step c. comprises the steps of:
providing and directly and dynamically anchoring first and second hoops to said opposed ends of said guitar so that said hoops freely pivot in alternate directions;
providing and removably engaging first and second slotted fastening members directly with said first and second hoops respectively, each of said first and second fastening members having a curvilinear hook formed at one end thereof and further having a neck provided with an eyelet formed at an opposite end thereof;
providing and pivotally coupling first and second triggers directly to said fastening members; and
said first and second triggers rotating along clockwise and counter clockwise directions respectively.

17. The method of claim 16, wherein step c. further comprises the steps of:
providing first and second orthogonally disposed fingers; and
simultaneously disengaging said first and second fingers from said first and second ends of said hook while remaining registered orthogonal to each other.

18. The method of claim 17, wherein step c. further comprises the steps of:
providing and directly attaching first and second auxiliary links to said first and second eyelets;
providing and directly mating first and second stabilizing plates with said first and second auxiliary links respectively; and
maintaining said chain spaced from said first and second fastening members and thereby ensuring that said first and second triggers remain disposed at closed positions during the twisting and turning movements by statically attaching distal and proximal ones of said rings directly to said first and second stabilizing plates.

19. The method of claim 15, wherein step c. comprises the steps of:
providing and directly mating a first coupling to one of said guitar ends;
providing and statically anchoring a proximal end of a first rectilinear anchor rod to said coupling while a distal end of said anchor rod extends away from said one guitar end respectively;
providing and rotatably engaging a chamfered bracket directly with said distal end of said anchor rod;
said chamfered bracket rotating along a first arcuate path, said chamfered bracket having a linear slot formed along a major longitudinal length thereof;
providing and slidably positioning a second rectilinear rod through said slot;
providing and attaching a second coupling to a proximal end of said second rod so that said second rod is prevented from being released from said slot;
providing and rotatably conjoining a tongue directly to a distal end of said second rod; and
freely articulating said tongue along a second arcuate path;
wherein said first and second arcuate paths are mutually exclusive.

20. The method of claim 19, further comprising the steps of:
simultaneously rotating said tongue about said second rod while said chamfered bracket rotates about said first rod;
communicating a linear motion to said second rod along a longitudinal length of said chamfered bracket with a varying velocity; and
continuously changing a spatial distance between said first and second rods.
